(19) United States
(12) Patent Application Publication
(10) Pub. No.: US 2008/0242362 A1
(43) Pub. Date: Oct. 2, 2008

(54) Rapid Content Association Methods

(75) Inventor: Matias Duarte, Los Angeles, CA (US)

Correspondence Address: K&L Gates LLP, STATE STREET FINANCIAL CENTER, One Lincoln Street, BOSTON, MA, 02111-2950, US

(73) Assignee: HELIO, LLC, Los Angeles, CA (US)

(21) Appl. No.: 12/055,635

(22) Filed: Mar. 26, 2008

Related U.S. Application Data
(60) Provisional application No. 60/920,299, filed on Mar. 26, 2007.

(51) Int. Cl. H04M 1/02; G06F 3/048

(52) U.S. Cl. 455/566; 715/764

(57) ABSTRACT

Methods and systems are provided for organizing the display of informational objects using a mobile device. Certain embodiments may be used to automatically search for related informational objects so that they can be viewed together with minimal user input and minimal user manipulation.

### CROSS REFERENCE TO RELATED APPLICATIONS

This application claims the benefit of U.S. Provisional Patent Application No. 60/920,299, filed Mar. 26, 2007 the entire disclosure of which is incorporated herein by reference in its entirety.

### FIELD OF THE INVENTION

The present invention relates generally to user interfaces for mobile electronic communications and, more particularly, to a system and method for organizing the display of informational objects using a mobile device.

### BACKGROUND OF THE INVENTION

As mobile electronic communications have proliferated, their importance has greatly increased. The volume of electronic communications, such as email and other mobile communications has also greatly increased, but the presentation of such communications has not significantly changed. In particular, mobile devices tend to isolate user content in information silos accessible only by drilling down through a series of menus associated with the type of content (e.g., email messages in the message area, pictures in the camera area). A user interface of this type may be adequate for users of desktop computers, but not for mobile users who need to access content with minimal input.

### SUMMARY OF THE INVENTION

Embodiments of the present invention provide systems and methods for organizing the display of informational objects using a mobile device. In more specific terms, certain embodiments may be used to automatically search for related informational objects so that they can be viewed together with minimal user input and minimal user manipulation.

In one general aspect of the present invention, the mobile device can be adapted to store informational objects and for automatically identifying a subset of the informational objects having a common attribute, such as all the informational objects associated with a given contact, and, upon receiving a single user action, for displaying a visual representation of each informational object in the subset in an organized fashion. In various aspects, the informational objects may include, for example, informational object types such email messages, pictures, audio, video, or text messages. Implementations may also include an input device for selecting the informational objects, such as when a single user action is received, and wherein the mobile device is adapted to derive the common attribute from the selected informational object. Various implementations may facilitate a user's search, navigation and exploration of the informational objects through modeless operation whereby users can initiate the organized information mode, such as by typing on the keypad, from any device mode including idle.

In another aspect the mobile device, includes an input device for selecting one of the plurality of informational objects, wherein the mobile electronic device is configured to derive the contact from an informational object selected using the input device when the single user action is received. In addition, in other embodiments, with respect to the mobile device each of the plurality of informational objects have an informational object type, and wherein the visual representation of each informational object in the subset includes displaying in separate tabs according to the informational object type. In still other embodiments, the mobile device includes an association module, implemented in hardware or software, that facilitates at least one of: the hierarchical arrangement of, the mapping of, the searching of, and/or the display of data on the mobile device.

In another general aspect of the present invention, a method of managing the display of information objects on a mobile device includes identifying a subset of information objects stored on the mobile device that have a common attribute; receiving a single user action indicative of the common attribute; and displaying the subset in an organized fashion, such as in a tabbed format. In some embodiments, the method further includes selecting the information object, deriving the common attribute or contact, and then displaying the subset organized by the common attribute or contact. In various aspects, the single user action may be received in any mode.

In another general aspect of the present invention, a computer program generates a graphical user interface that includes a visual representation of a tab and a visual representation of the informational objects associated with the tab wherein each informational object associated with the tab has a common attribute, defined by a tag or other metadata. For example, the subset of informational objects associated with the tab may be associated with the same contact. In some embodiments, the tabs may be used to organize the informational objects by informational object type, such by as email, audio, video, picture, or text messages.

### BRIEF DESCRIPTION OF THE DRAWINGS

These embodiments and other aspects of this invention will be readily apparent from the detailed description below and the appended drawings, which are meant to illustrate and not to limit the invention, and in which:

FIG. 1 is a functional block diagram that illustrates the components of an exemplary system for practicing an embodiment of the present invention;

FIG. 2 is a schematic diagram that illustrates a mobile device according to an embodiment of the present invention;

FIG. 3 is a schematic diagram that illustrates an exemplary non-contact-specific display screen according to an embodiment of the present invention;

FIGS. 4-7 are schematic diagrams that illustrate exemplary contact-specific display screens according to an embodiment of the present invention; and

FIG. 8 is a high-level flow chart illustrating exemplary steps involved in practicing an embodiment of the present invention.

### DETAILED DESCRIPTION OF THE PREFERRED EMBODIMENTS

The present invention will be more completely understood through the following detailed description, which should be read in conjunction with the attached drawings. In this description, like numbers refer to similar elements within various embodiments of the present invention. Within this detailed description, the claimed invention will be explained with respect to preferred embodiments. However, the skilled artisan will readily appreciate that the methods and systems described herein are merely exemplary and that variations can be made without departing from the spirit and scope of the invention.

Embodiments of the present invention relate to a system and method for managing the display of informational objects on a mobile device. Some embodiments relate to viewing and navigating relationships between informational objects with minimal user input and minimal user manipulation of displayed objects. For example, an embodiment of the present invention may be used to sort messages in a message store that have a common characteristic, such as those sent to or from a certain person. According to such an embodiment, all messages in a message store may be automatically sorted by sender and cached so that, upon receiving a single user action, a resulting subset of messages can be viewed, such as in a series of tabs with one tab for each sender. In an embodiment, the tabs are accessible using left or right navigation buttons on the mobile device or in any convenient manner.

In the following discussion of illustrative embodiments, a “mobile device” includes, without limitation, mobile phones, personal digital assistants, hand-held computers, ultra-mobile personal computers, and the like. The term “softkey” includes, without limitation, a hard key without a fixed function, or alternatively, a virtual or screen button that appears on a touch screen. In either configuration, softkeys may be programmed to perform dynamic functions. The term “user” refers to an individual using a mobile device. The term “automatically” means without human intervention. The term “idle screen” refers to the default screen displayed when the mobile device is switched on or when the user is not navigating to a particular function, nor actively using a particular application. The term “informational object” refers to information, in any form, than can be either directly or indirectly associated with an individual including, but not limited to, email, audio, video, pictures, and text messages. The term “contact” refers to any individual and/or entity with which a user of a mobile device is associated, has communicated, and/or desires to communicate.

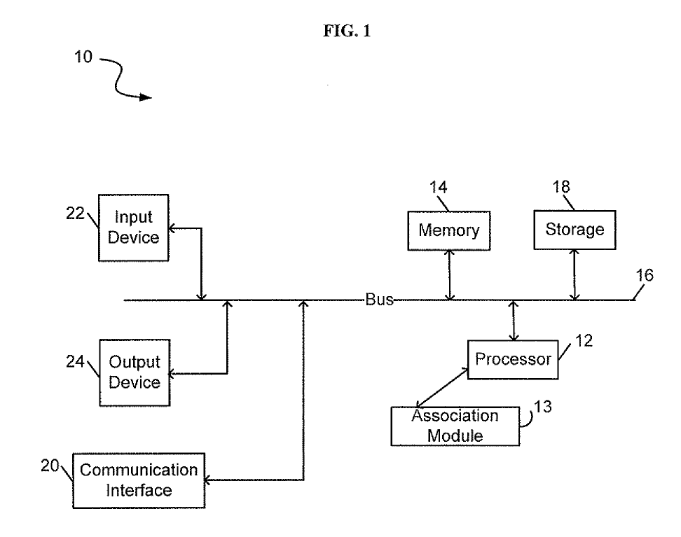

FIG. 1 is a functional block diagram that illustrates the components of an exemplary mobile device 10 for practicing an embodiment of the present invention. Mobile device 10 preferably includes a processing unit 12, a system memory 14, a disk storage 18, a communication interface 20, an input device 22, an output device 24, and a system bus 16. System bus 16 couples system components including, but not limited to, system memory 14 to processing unit 12. The processing unit 12 can be any of various available processors. An association module 13 is typically in communication with the processing unit 12 and adapted to, in part, facilitate tab-wise and other hierarchical arrangements of data on a mobile device.

Input device 22 may be a keyboard, thumbboard, or touchscreen (for use with a stylus) that are used to receive data from a user. In addition, input device 22 can also include a plurality of other inputs or controls for adjusting and configuring one or more aspects of the present invention including voice commands. Output device 24 may be a display device, such as an LCD or LED display screen, that can display one or more display objects (not shown) such as configurable icons, buttons, input boxes, menus, tabs, softkey labels and so forth having multiple configurable dimensions, shapes, colors, text, data and sounds to facilitate operations with mobile device 10.

Communication interface 20 facilitates data exchange over a variety of wireless networks. The hardware and software necessary for connection to the communication interface 20 includes, for exemplary purposes only, internal and external components that transmit and receive data wirelessly across a plurality of standard protocols including, for example, PCS, GSM, CDMA, Bluetooth, WiFi, IrDA, WiMAX, WiBRO or through other known wireless standards.

Storage 18 may include removable or fixed, volatile or non-volatile or permanent or re-writable computer storage media. The computer readable medium can be any available medium that can be accessed by a general purpose or special purpose mobile device. By way of example, and not limitation, such a computer readable medium can comprise flash memory, RAM, ROM, electrically erasable programmable read only memory (EEPROM), optical disk storage, magnetic disk storage or other magnetic storage devices, or any other medium that can be used to store digital information on a mobile device.

It is to be appreciated that FIG. 1 describes software that acts as an intermediary between users and the basic resources described in mobile device 10. Such software preferably includes an operating system. The operating system, which can be resident in storage 18, acts to control and allocate resources of mobile device 10. System applications take advantage of the management of resources by the operating system through program modules and program data stored either in system memory 14 or on disk storage 18. Furthermore, it is to be appreciated that the present invention can be implemented with various operating systems or combinations of operating systems.

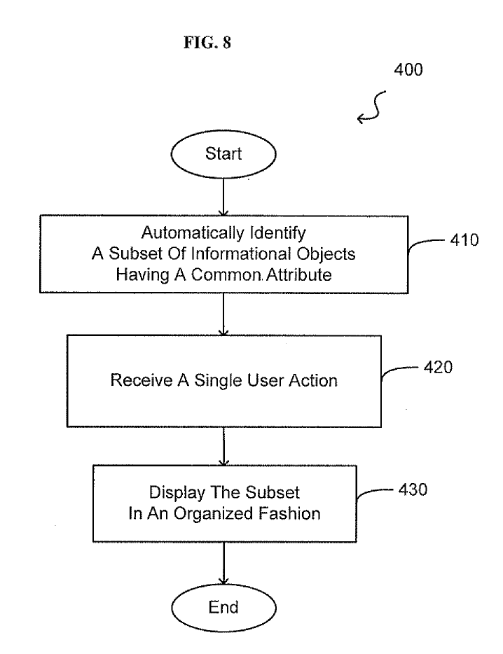

The computer readable medium tangibly embodies a program, functions, and/or instructions that cause the computer system to operate in a specific and predefined manner as described herein. Those skilled in the art will appreciate, however, that the process described below, such as the process illustrated in FIG. 8, may be implemented at any level, ranging from hardware to application software and in any appropriate physical location. For example, the present invention may be implemented as software code to be executed by mobile device 10 using any suitable computer language and may be stored on any of the storage media described above, or can be configured into the logic of mobile device 10. Such software code may be executed by mobile device 10 using any suitable computer language such as, for example, Java, Javascript, C++, C, C#, Perl, Visual Basic, Transact/Structure Query Language (T/SQL), database languages, APIs, various system-level SDKs, assembly, firmware, microcode, and/or other languages and tools.

These are representative components of a mobile device whose operation is well understood. Furthermore, those of ordinary skill in the art will appreciate that mobile device 10 of FIG. 1 is exemplary only and that the present invention can operate within a number of different mobile devices.

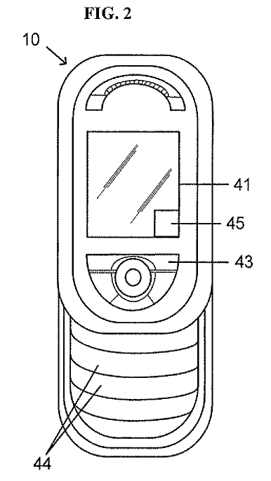

FIG. 2 is schematic diagram that illustrates mobile device 10 that may be used for organizing the display of informational objects according to an embodiment of the present invention. Mobile device 10 includes an input device such as a keypad 44 with individual keys for entering characters, numbers, or symbols. Further, Mobile device 10 includes a softkey label 45 drawn on a display screen 41 adjacent to softkey 43, so that the function and action associated with the softkey may be readily defined and re-defined according to the particular state of the user interface. When pressed or otherwise activated in any mode, including idle, a key, or a sequences of keys on the keypad 44, or a softkey 43 causes mobile device 10 to display in an organized fashion related informational objects cached on mobile device 10 and/or associated with a host computer system. Informational objects may be organized through the use of metadata originally associated with an object or specified by either the user or the system for organizational purposes. According to an embodiment, mobile device 10 is configured to automatically sort and cache informational objects using a pre-defined scheme, such as by automatically sorting and caching the informational objects by contact, so that the user need only enter a search term, or a single alphanumeric key on the keypad 44, or activate softkey 43 to display the results in an organized fashion.

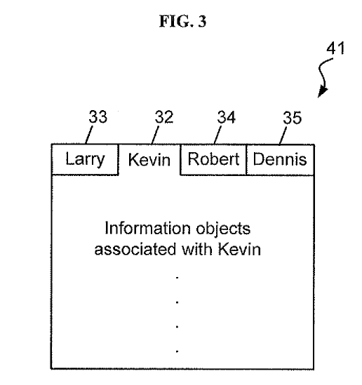

FIG. 3 is a schematic diagram that illustrates an exemplary display screen 41 that may be displayed on mobile device 10 following a press or activation of softkey 43 or another key or keys on the keypad 44. Display screen 41 includes tabs 32, 33, 34, and 35 that display informational objects associated with contacts Larry, Kevin, Robert, and Dennis, respectively.

In the illustrated embodiment, tab 32 displays all of the informational objects stored on mobile device 10 associated with Kevin. More generally, the embodiment illustrated in FIG. 3 displays informational objects by a common attribute (e.g., communications with Kevin) rather than by file type. Although the specifics of displaying each search result can vary with a user's preference, in one embodiment, the subset of related informational objects are presorted and displayed by the date received. Those skilled in the art will appreciate that tab 32 can display combinations of informational objects having a common attribute.

Although the embodiments illustrated herein include a softkey as a mechanism for initiating a search or the organized information mode, virtually any mechanism configured to capture a user command, whether displayed or not, can be used to initiate a search or the organized information mode without departing from the principles of the invention. Additionally, embodiments of the present invention allow users to initiate a search or the organized information mode from device modes other than idle.

In other embodiments, the mechanism for initiating a search or the organized information mode includes a particular contact. For example, a user of mobile device 10 may input or otherwise identify a contact so that informational objects associated with the contact will be displayed. A contact may be input using input device 22 or otherwise identified in a number of ways known to those skilled in the art without departing from the principles of the invention. In an embodiment relating to keypad input, a search may begin as soon as the first key entry is received, and is refined as successive keys are pressed by the user conducting the search. Thereby, the database on the mobile electronic device can be searched to locate and return individuals whose names or data match the search term. For example, to display informational objects related to Kevin, the user may input “538,” which corresponds to “kev” on the keypad of mobile device 10. Mobile device 10 may be configured to identify contacts related to one or more informational objects stored on mobile device 10. If more than one contact matches “kev,” mobile device 10 may display a list of the matching contacts from which the user may choose.

In some embodiments of the present invention, mobile device 10 may implement “suggest” technology to aid the user by providing a list of likely search queries. In such an embodiment, mobile device 10 offers “auto complete” options based on several factors such as user history, real-time lookups in a local phonebook, favorites modules, “buddy lists” and related historical search queries aggregated among all users of a mobile search platform. Mobile device 10 may further evaluate in real time, the extent to which it offers such suggestions based on a number of other factors including a “confidence score” provided to minimize annoying user experience.

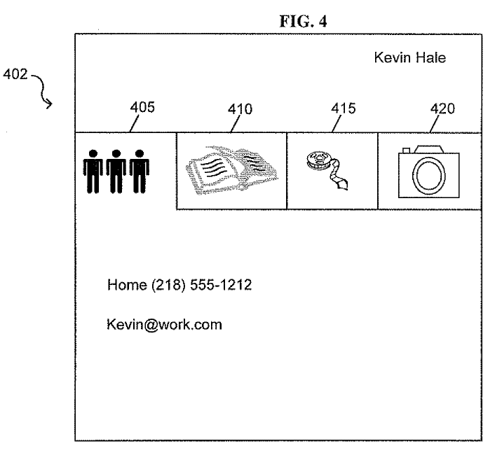

According to an embodiment of the present invention, mobile device 10 may be configured to determine the contact from an informational object selected when it receives an initiation signal from the user. For example, if the user highlights or otherwise selects an informational object related to a particular contact, such as an email message from Kevin in the inbox, mobile device 10 may be configured to respond to an initiation signal from the user that causes informational objects related to Kevin to be displayed in the organized information mode, such as that shown in FIG. 4.

FIG. 4 is a schematic diagram that illustrates an exemplary user interface 402 that may be displayed on mobile device 10 in accordance with an embodiment of the present invention. User interface 402 includes a series of tabs that contain information relating to Kevin, including a contact information tab 405, a communication history tab 410, a media tab 415, and a pictures tab 420. In the illustrated embodiment, contact information tab 405 includes Kevin's telephone number and email address. Those skilled in the art will appreciate that contact information tab 405 may include additional descriptive information, such as Kevin's postal address, telephone number, e-mail address, fax number, instant messaging nickname, birthdate, spouse's name, likes and dislikes.

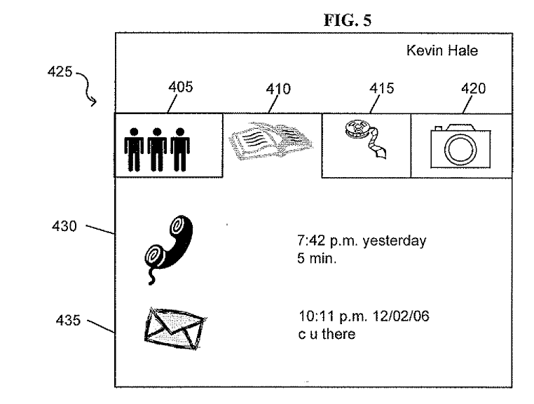

FIG. 5 is a schematic diagram that illustrates an exemplary user interface 425 that is similar in many respects to user interface 402 except that user interface 425 shows communication history tab 410 as selected. In the illustrated embodiment, communication history tab 410 includes a telephone call 430 received from Kevin and a message 435 sent to Kevin. Message 435 may be communicated in accordance with any telephony messaging system, such as SMS, MMS, or IMS, without departing from the principles of the invention. Those skilled in the art will appreciate that communication history tab 410 may include other forms of communication beyond those illustrated in communication history tab 410. In some embodiments, communication history tab 410 includes informational objects associated with Kevin beyond those sent to or from Kevin. For example, communication history tab 410 may include messages in which Kevin is identified in the body of the message or in the message header, such as by copy or blind copy.

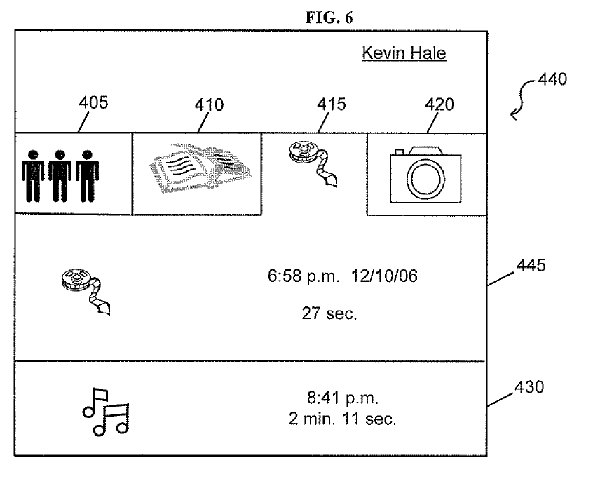

FIG. 6 is a schematic diagram that illustrates an exemplary user interface 440 that is similar in many respects to user interface 402 except that user interface 440 shows media tab 415 as selected. In the illustrated embodiment, media tab 415 includes a video 445 from Kevin and a music file 450 sent to Kevin. Like tab 410, media tab 415 may include informational objects associated with Kevin beyond those sent to or from Kevin. For example, media tab 410 may include a video having a tag or other metadata that identifies Kevin.

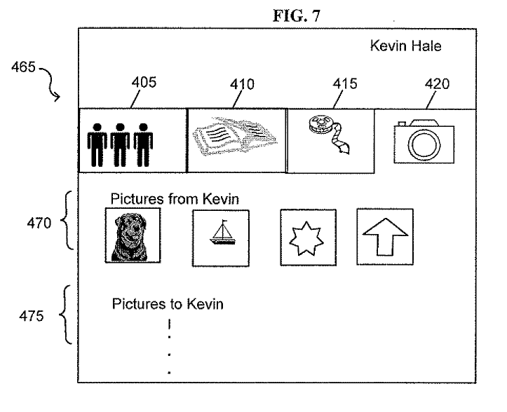

FIG. 7 is a schematic diagram that illustrates an exemplary user interface 465 that is similar in many respects to user interface 402 except that user interface 465 shows picture tab 420 as selected. In the illustrated embodiment, photo tab 420 includes a plurality of pictures 470 from Kevin and a plurality of pictures 475 sent to Kevin. Like tab 415, tab 420 may include pictures with tags or other metadata that identifies Kevin. Pictures displayed in tab 420 may also be identified as associated with Kevin through image recognition techniques.

FIG. 8 is a process diagram that illustrates an exemplary method 400 for practicing an embodiment of the present invention. In step 410, mobile device 10 automatically identifies one or more subsets of informational objects each having a predefined attribute common to each subset. According to the example illustrated in FIG. 3, step 410 would automatically identify and presort the informational objects related to each contact, namely Larry, Kevin, Robert, and Dennis. According to the example illustrated in FIG. 4 through FIG. 7, step 410 would automatically identify and presort the informational objects related to contacts stored on mobile device 10 including, in this example, Kevin.

In step 420, a single user input is received that requests access to the informational objects pre-searched and pre-sorted in step 410. According to an embodiment, the single user action may be a press of softkey 43. However, the single-user action can also be the actuation of any hardkey, button, or other interface in communication with the mobile device. As discussed previously, each individual or contact returned would be associated with all of the communications, content, contact information, descriptive information and the like relating to that individual. According to the embodiment illustrated in FIG. 4 through FIG. 7, step 420 includes receiving a particular contact.

In step 430, the subset of returnable entries is displayed in an organized fashion, such as by displaying the informational objects in a non-contact-specific format, as illustrated in FIG. 3, or a contact-specific format, as illustrated in FIG. 4 through FIG. 7.

Variations, modifications, and other implementations of what is described herein will occur to those of ordinary skill in the art without departing from the spirit and scope of the invention as claimed. Accordingly, the invention is to be defined not by the preceding illustrative description but instead by the spirit and scope of the following claims.

1. A mobile electronic device comprising:
a processor;
a storage medium on which resides a plurality of informational objects, wherein each informational object is associated with an attribute; and
a memory for storing computer readable instructions that, when executed by the processor, cause the processor to automatically identify a subset of the plurality of informational objects having a common attribute and, upon receiving a single user action, to display a visual representation of each informational object in the subset in an organized fashion.

2. The mobile electronic device of claim 1 wherein the plurality of informational objects include electronic mail messages.

3. The mobile electronic device of claim 1 wherein the plurality of informational objects include pictures.

4. The mobile electronic device of claim 1 wherein the common attribute is a contact associated with each informational object in the subset.

5. The mobile electronic device of claim 4 further comprising,
an input device for selecting one of the plurality of informational objects, wherein the mobile electronic device is configured to derive the contact from an informational object selected using the input device when the single user action is received.

6. The mobile electronic device of claim 1 wherein each of the plurality of informational objects have an informational object type, and wherein the visual representation of each informational object in the subset includes displaying in separate tabs according to the informational object type.

7. The mobile electronic device of claim 1 adapted to display an icon for receiving the single user action.

8. The mobile electronic device of claim 1 adapted to receive the single user action from an idle screen.

9. The mobile electronic device of claim 1 adapted to receive the single user action from any mode.

10. The mobile electronic device of claim 1 wherein the single user action includes identifying a contact.

11. A method of managing the display of informational objects on a mobile device, comprising:
automatically identifying a subset of informational objects stored on the mobile device having a common attribute;
receiving a single user action indicative of the common attribute; and
after receiving the single user action, displaying the subset in an organized fashion.

12. The method of claim 11 wherein displaying includes displaying the subset in a tabbed format.

13. The method of claim 11 the single user action is received in any mode.

14. The method of claim 11 the common attribute is a contact.

15. The method of claim 14 further comprising,
selecting an informational object; and
deriving the contact from the selected informational object after receiving the single user action.

16. A system for managing the display of informational objects on a mobile device, comprising:
means for automatically identifying a subset of informational objects stored on the mobile device having a common attribute;
means for receiving a single user action indicative of the common attribute; and
after receiving the single user action, displaying the subset in an organized fashion.

17. A computer program that, when executed, generates a graphical user interface on a display of a mobile device, the graphical user interface comprising:
a visual representation of a tab; and
a visual representation of a plurality of informational objects associated with the tab, wherein the plurality of informational objects have a common attribute.

18. The graphical user interface of claim 17 wherein the common attribute is a contact.

19. The graphical user interface of claim 17 wherein the common attribute is a tag.

20. The graphical user interface of claim 17 wherein the plurality of informational objects have a common informational object type.

21. The graphical user interface of claim 20 wherein the common informational object type is selected from the group consisting of email, audio, video, picture, and text message.
